(19) United States
(12) Patent Application Publication
(10) Pub. No.: US 2017/0289492 A1
(43) Pub. Date: Oct. 5, 2017

(54) TELEVISION

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Xiaosheng Tian, Tianjin (CN)

(21) Appl. No.: 15/234,616

(22) Filed: Aug. 11, 2016

Related U.S. Application Data
(63) Continuation of application No. PCT/CN2016/088985, filed on Jul. 6, 2016.

(30) Foreign Application Priority Data
Mar. 29, 2016 (CN) 201620252678.3

(51) Int. Cl. H04N 5/64; H04R 5/02

(52) U.S. Cl. CPC H04N 5/642; H04R 5/02; H04R 2499/15

(57) ABSTRACT

The application relates to the field of display technologies, and disclose a television including a housing, and a left channel speaker and a right channel speaker, both of which are arranged in the housing, wherein: the left channel speaker includes a left box body, and a left high frequency speaker driver, a left mid frequency speaker driver, and a left low frequency speaker driver, all of which are installed in the left box body, wherein the left high frequency speaker driver, the left mid frequency speaker driver, and the left low frequency speaker driver are arranged in that order in the direction from the left channel speaker to the right channel speaker; and the right channel speaker includes a right box body, and a right high frequency speaker driver, a right mid frequency speaker driver, and a right low frequency speaker driver, all of which are installed in the right box body, wherein the right high frequency speaker driver, the right mid frequency speaker driver, and the right low frequency speaker driver are arranged in that order in the direction from the right channel speaker to the left channel speaker.

### CROSS REFERENCE TO RELATED APPLICATIONS

This disclosure is a continuation of International Application No. PCT/CN2016/088985, filed on Jul. 6, 2016, which is based upon and claims priority to Chinese Patent Application No. 201620252678.3, filed on Mar. 29, 2016, the entire contents of which are incorporated herein by reference.

### TECHNICAL FIELD

The present disclosure relates to the field of display technologies, and particularly to a television.

### BACKGROUND

The size of a television has become increasingly thinner in the field of display devices, but the inventors of the application have identified during making of the application the following drawback of the existing television despite a high-definition and ultra-thin visual experience of people brought by the television:

A dual-channel and two-way television speaker system located in the television has become increasingly light-weighted and thinned, and consequently may not offer an increasingly pronounced sound effect satisfactory to users; and at present a traditional three-way speaker cannot be integrated in such a narrow television structure, so it is highly desirable to design a television structure capable of offering a three-way sound effect.

### SUMMARY

The disclosure provides a television including a housing, and a left channel speaker and a right channel speaker, both of which are arranged in the housing, wherein:

the left channel speaker includes a left box body, and a left high frequency speaker driver, a left mid frequency speaker driver, and a left low frequency speaker driver, all of which are installed in the left box body, wherein the left high frequency speaker driver, the left mid frequency speaker driver, and the left low frequency speaker driver are arranged in that order in the direction from the left channel speaker to the right channel speaker; and

the right channel speaker includes a right box body, and a right high frequency speaker driver, a right mid frequency speaker driver, and a right low frequency speaker driver, all of which are installed in the right box body, wherein the right high frequency speaker driver, the right mid frequency speaker driver, and the right low frequency speaker driver are arranged in that order in the direction from the right channel speaker to the left channel speaker.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a television according to some embodiments of the application;

FIG. 2 is a schematic diagram of a left channel speaker according to some embodiments of the application; and

FIG. 3 is a schematic diagram of a right channel speaker according to some embodiments of the application.

### REFERENCE NUMERALS

In the embodiments of the application:

1—Housing;

2—Left channel speaker;

21—Left high frequency speaker driver;

22—Left mid frequency speaker driver;

23—Left low frequency speaker driver;

24—Left box body;

3—Right channel speaker;

31—Right low frequency speaker driver;

32—Right mid frequency speaker driver;

33—Right high frequency speaker driver;

34—Right box body.

### DETAILED DESCRIPTION

Various exemplary embodiments of the application will be described below in details with reference to the drawings. It shall be noted that unless stated otherwise, relative arrangements of components and steps, numeral expressions, and values, which are set forth in these embodiments will not limit the scope of the application.

The following description of at least one exemplary embodiment is merely illustrative indeed, but not intended to limit the application and its applications or uses in any way.

Techniques, methods, and devices known to those skilled in the art may not be discussed in details, but shall be construed as a part of the specification if appropriate.

Any particular values throughout the examples illustrated and discussed here shall be constructed as merely illustrative, but not intended to be limiting. Accordingly, there may be different values in other examples of the exemplary embodiments.

It shall be noted that like reference numerals and symbols will refer to like elements throughout the drawings, so if some element is defined in one of the drawings, then it will not be further discussed in subsequent drawings.

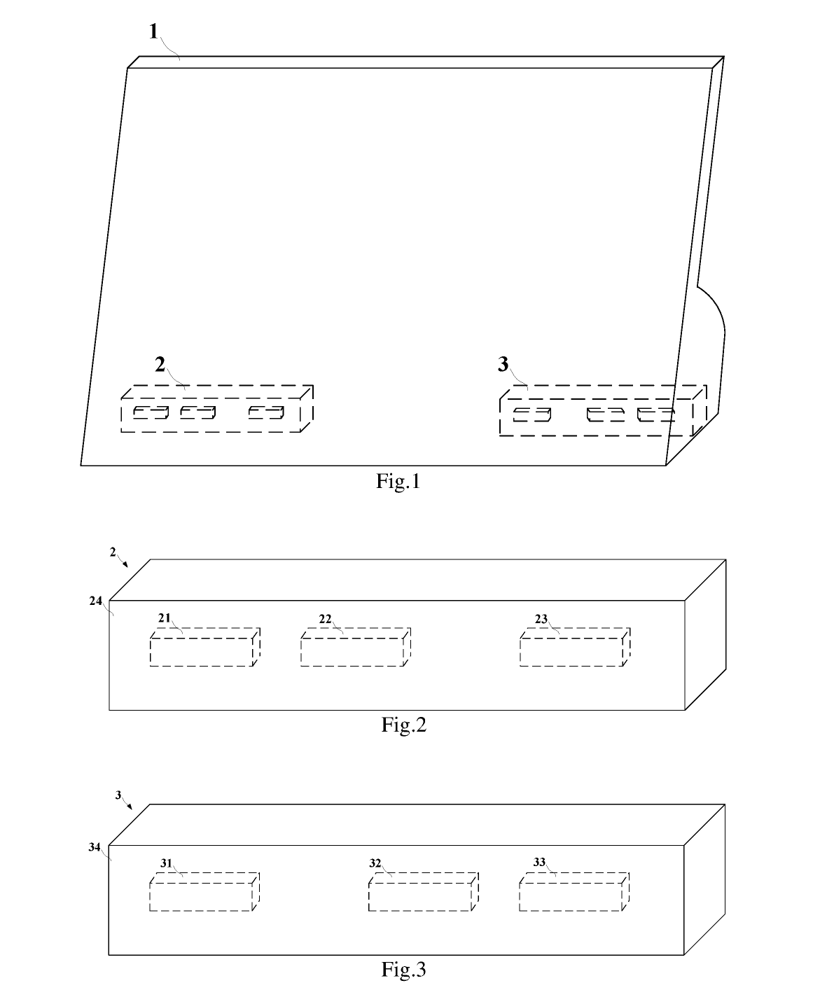

As illustrated in FIG. 1, FIG. 2, and FIG. 3, a television according to an embodiment of the application includes a housing 1, and a left channel speaker 2 and a right channel speaker 3, both of which are arranged in the housing 1, where:

The left channel speaker 2 includes a left box body 24, and a left high frequency speaker driver 21, a left mid frequency speaker driver 22, and a left low frequency speaker driver 23, all of which are installed in the left box body 24, where the left high frequency speaker driver 21, the left mid frequency speaker driver 22, and the left low frequency speaker driver 23 are arranged in that order in the direction from the left channel speaker 2 to the right channel speaker 3; and

The right channel speaker 3 includes a right box body 34, and a right high frequency speaker driver 33, a right mid frequency speaker driver 32, and a right low frequency speaker driver 31, all of which are installed in the right box body 34, where the right high frequency speaker driver 33, the right mid frequency speaker driver 32, and the right low frequency speaker driver 31 are arranged in that order in the direction from the right channel speaker 3 to the left channel speaker 2.

In the technical solution according to the embodiment of the application, the left high frequency speaker driver 21, the left mid frequency speaker driver 22, and the left low frequency speaker driver 23 of the left channel speaker 2 generate a left high frequency tone, a left mid frequency tone, and a left low frequency tone respectively to thereby create a three-way sound effect in the left channel, and also the left high frequency tone, the left mid frequency tone, and the left low frequency tone are integrated in the left channel and emitted by the left channel speaker 2, so that the left channel speaker 2 simple in structure, and compact in size as a whole can achieve the three-way sound effect; and the right high frequency speaker driver 33, the right mid frequency speaker driver 32, and the right low frequency speaker driver 31 of the right channel speaker 3 generate a right high frequency tone, a right mid frequency tone, and a right low frequency tone respectively to thereby create a three-way sound effect in the right channel, and also the right high frequency tone, the right mid frequency tone, and the right low frequency tone are integrated in the right channel and emitted by the right channel speaker 3, so that the right channel speaker 3 simple in structure, and compact in size as a whole can achieve the three-way sound effect. Moreover the left low frequency speaker driver 23 and the right low frequency speaker driver 31 are proximate to the middle of the housing 1, and the left mid frequency speaker driver 22, the right mid frequency speaker driver 32, the left high frequency speaker driver 21, and the right high frequency speaker driver 33 are proximate to two sides of the housing 1, where the left high frequency speaker driver 21 and the right high frequency speaker driver 33 are arranged correspondingly on the two sides of the housing 1, so that the high frequency tones of the left and right channels are further from each other to thereby create a wider sound field horizontally and vertically for a better sound effect.

Thus the television according to the embodiment of the application can achieve the three-way sound effect and a better sound effect in the thinner structure.

As illustrated in FIG. 1, in an optional embodiment, the left low frequency speaker driver 23 and the right low frequency speaker driver 31 emit their sounds toward behind the housing 1; and

The left mid frequency speaker driver 22, the left high frequency speaker driver 21, the right mid frequency speaker driver 32, and the right high frequency speaker driver 33 emit their sounds toward below the housing 1.

The left low frequency speaker driver 23 and the right low frequency speaker driver 31 emit their sounds toward behind the housing 1 so that the sounds are propagated away from the user, and the left mid frequency speaker driver 22, the left high frequency speaker driver 21, the right mid frequency speaker driver 32, and the right high frequency speaker driver 33 emit their sounds toward below the housing 1 to thereby avoid the sounds from being propagated directly toward the user so as to alleviate the sounds from influencing the user, and to mix the three-way sounds being propagated for a better sound effect.

In an optional embodiment, the housing 1 includes a face housing and a back housing, where the left channel speaker 2 and the right channel speaker 3 are fixed on the back housing. The left channel speaker 2 and the right channel speaker 3 can be installed on the back housing so that the assembly thereof is simple in structure, and convenient to install and transport.

In at least one embodiment, the left box body 24 and the right box body 34 can be structured with the back housing as follows:

In a first approach, the left box body 24 is structured integral to the back housing, and the right box body 34 is installed on the back housing;

In a second approach, the right box body 34 is structured integral to the back housing, and the left box body 24 is installed on the back housing; and

In a third approach, the left box body 24 is structured integral to the back housing, and the right box body 34 is structured integral to the back housing.

With the integral structure above, the entire television can be convenient to assemble, pleasing in appearance as a whole, produced in an optimized process, and better have a sound short-circuit of the speaker drivers eliminated, sound resonance thereof suppressed, and a frequency response range thereof widen to thereby alleviate distortion so as to achieve a better sound effect.

In at least one embodiment, the television can further include a stand on which the housing 1 is installed, or the television can be further fixed on a wall by being hung thereon, dependent upon particular conditions of the television and the user.

As illustrated in FIG. 1, in an optional embodiment, the left channel speaker 2 and the right channel speaker 3 are arranged symmetric on the two sides of the housing. They can be arranged as such in a simple process to thereby avoid their influence on a balance of the television.

Although some particular embodiments of the application have been described in details by way of an example, those skilled in the art shall appreciate that the examples above are merely intended to illustrate but not limit the scope of the application. Those skilled in the art shall appreciate that the embodiments above can be modified without departing from the spirit and scope of the application. The scope of the application shall be as defined in the appended claims.

What is claimed is:

1. A television, comprising a housing, and a left channel speaker and a right channel speaker, both of which are arranged in the housing, wherein:
the left channel speaker comprises a left box body, and a left high frequency speaker driver, a left mid frequency speaker driver, and a left low frequency speaker driver, all of which are installed in the left box body, wherein the left high frequency speaker driver, the left mid frequency speaker driver, and the left low frequency speaker driver are arranged in that order in the direction from the left channel speaker to the right channel speaker; and
the right channel speaker comprises a right box body, and a right high frequency speaker driver, a right mid frequency speaker driver, and a right low frequency speaker driver, all of which are installed in the right box body, wherein the right high frequency speaker driver, the right mid frequency speaker driver, and the right low frequency speaker driver are arranged in that order in the direction from the right channel speaker to the left channel speaker.

2. The television according to claim 1, wherein the left low frequency speaker driver and the right low frequency speaker driver emit their sounds toward behind the housing; and
the left mid frequency speaker driver, the left high frequency speaker driver, the right mid frequency speaker driver, and the right high frequency speaker driver emit their sounds toward below the housing.

3. The television according to claim 1 wherein the housing comprises a face housing and a back housing, wherein the left channel speaker and the right channel speaker 3 are fixed on the back housing.

4. The television according to claim 2, wherein the housing comprises a face housing and a back housing, wherein the left channel speaker and the right channel speaker 3 are fixed on the back housing.

5. The television according to claim 3, wherein the left box body is structured integral to the back housing, and/or the right box body is structured integral to the back housing.

6. The television according to claim 3, wherein the television further comprises a stand on which the housing is installed.

7. The television according to claim 3, wherein the left channel speaker and the right channel speaker are arranged symmetric on two sides of the back housing.

8. The television according to claim 1 wherein the left channel speaker and the right channel speaker are arranged symmetric on two sides of the housing.

9. The television according to claim 2, wherein the left channel speaker and the right channel speaker are arranged symmetric on two sides of the housing.

10. The television according to claim 5, wherein the left channel speaker and the right channel speaker are arranged symmetric on two sides of the housing.

11. The television according to claim 6, wherein the left channel speaker and the right channel speaker are arranged symmetric on two sides of the housing.
